(19) United States
(12) Patent Application Publication
(10) Pub. No.: US 2019/0072056 A1
(43) Pub. Date: Mar. 7, 2019

(54) EXHAUST GAS RECIRCULATION DEVICE

(71) Applicants: Hyundai Motor Company, Seoul (KR); Kia Motors Corporation, Seoul (KR)

(72) Inventors: Sung Il Yoon, Seoul (KR); Dong Young Lee, Goyang (KR); Do Jun Park, Hwaseong (KR); In Sung Yun, Seoul (KR); Seung Woo Ko, Seoul (KR)

(21) Appl. No.: 15/822,018

(22) Filed: Nov. 24, 2017

(30) Foreign Application Priority Data
Sep. 7, 2017 (KR) 10-2017-0114573

(51) Int. Cl. F02M 26/19; F02M 26/28

(52) U.S. Cl. CPC F02M 26/19; F02M 26/28

(57) ABSTRACT

An exhaust gas recirculation (EGR) device includes a cylinder head in which an EGR passage that recirculates EGR gas from an exhaust side to an intake side is formed; a coolant chamber formed inside the cylinder head and at a circumference of the EGR passage, through which coolant cooling the EGR gas passing through the EGR passage passes; and a swirl generator disposed at one side of the EGR passage to form swirl at the EGR gas passing through the EGR passage.

### CROSS-REFERENCE TO RELATED APPLICATION

This application claims under 35 U.S.C. § 119(a) the benefit of Korean Patent Application No. 10-2017-0114573 filed in the Korean Intellectual Property Office on Sep. 7, 2017, the entire contents of which are incorporated herein by reference.

### BACKGROUND

### (a) Technical Field

The present disclosure relates to an engine, more particularly, to an exhaust gas recirculation device which recirculates a portion of exhaust gas from an exhaust side to an intake side to lower a temperature of a combustion chamber, so as to reduce nitrogen oxide generation and reduce fuel consumption.

### (b) Description of the Related Art

Generally, an EGR (Exhaust Gas Recirculation) device recirculates a portion of exhaust gas (hereinafter, referred to as “EGR gas”) from an exhaust side to an intake side of an engine, and the EGR gas is mixed with outside air to be supplied to a combustion chamber.

In particular, when the exhaust gas recirculates, the combustion temperature becomes low to suppress generation of nitrogen oxide (NOx) and reduce fuel consumption by reusing uncombusted fuel.

A conventional EGR device typically is installed between an exhaust manifold from which combusted exhaust gas is exhausted and an intake manifold guiding intake air to recirculate a portion of the exhaust gas passing through the exhaust manifold (EGR gas) to the intake manifold.

Further, the EGR device is installed on an EGR line, and includes an EGR valve opening and closing a passage of an EGR pipe and an EGR cooler cooling the EGR gas passing through the EGR line.

The EGR pipe is connected to both ends of the EGR cooler, and an inlet at which coolant enters the engine is formed at one side of the EGR pipe, and an outlet at which the coolant exits is formed at another side of the EGR pipe, such that the EGR gas may be cooled by the coolant passing through the EGR cooler.

In the conventional EGR device, because capacity of the EGR cooler has to be increased for effective cooling of the EGR gas, back pressure, weight and size must be increased, but installation space may be restricted.

The above information disclosed in this Background section is only for enhancement of understanding of the background of the disclosure and therefore it may contain information that does not form the prior art that is already known in this country to a person of ordinary skill in the art.

### SUMMARY

The present disclosure provides an exhaust gas recirculation device which does not increase capacity of an EGR cooler and cools the EGR gas in advance, so as to prevent an increase of back pressure.

An exhaust gas recirculation device according to an exemplary embodiment of the present disclosure includes a cylinder head in which an EGR passage recirculating EGR gas from an exhaust side to an intake side is formed; a coolant chamber formed inside the cylinder head and at a circumference of the EGR passage, through which coolant cooling the EGR gas passing through the EGR passage passes; and a swirl generator disposed at one side of the EGR passage to form swirl at the EGR gas passing through the EGR passage.

The exhaust gas recirculation device may further include a first EGR line connecting an exhaust manifold connected to an exhaust side of the cylinder head and an inlet side of the EGR passage; and a second EGR line connecting an outlet side of the EGR passage and an intake manifold connected to the intake side of the cylinder head.

The swirl generator may be disposed at an inlet of the EGR passage.

The exhaust gas recirculation device may further include an EGR valve installed at one side of the second EGR line to control the recirculating exhaust gas; and an EGR cooler installed at another side of the second EGR line to cool the recirculating exhaust gas.

The swirl generator may include an outer pipe closely contacting an interior circumference of the EGR passage; an inner pipe disposed in a predetermined interval with an interior circumference of the outer pipe; and a swirl generating wing formed between the inner pipe and the outer pipe to form swirl at the passing EGR gas.

The exterior circumference of the outer pipe may be fixed at the interior circumference of the EGR passage, and a center hole through which the EGR gas passes may be formed at a center portion of the inner pipe.

The exhaust gas recirculation device according to an exemplary embodiment of the present disclosure includes a cylinder head in which an EGR passage recirculating EGR gas from an exhaust side to an intake side is formed; a coolant chamber formed inside the cylinder head and at a circumference of the EGR passage, through which coolant cooling the EGR gas passing through the EGR passage passes; and a swirl generator disposed at an inlet side of the EGR passage to form swirl at the EGR gas passing through the EGR passage, wherein the swirl generator includes an outer pipe closely contacting and being fixed with interior circumference of the EGR passage; an inner pipe disposed in a predetermined interval with an interior circumference of the outer pipe, and a center hole through which the EGR gas passes is formed at a center portion; and a swirl generating wing formed between the inner pipe and the outer pipe to form swirl at the passing EGR gas.

According to the exemplary embodiments of the present disclosure, the EGR gas passages through the EGR passage formed inside the cylinder head and a coolant chamber is formed at a circumference of the EGR passage, therefore the EGR gas may be effectively cooled before the EGR cooler reaches the EGR cooler.

Also, an EGR line bypassing the cylinder head is not separately provided, and an EGR passage through which the EGR gas passes is provided inside the cylinder head, such that weight may be decreased and a layout simplified.

Further, a swirl generator is provided at the EGR passage, and cooling efficiency may be improved and the EGR gas may rapidly pass through the EGR passage while the EGR gas passes through the EGR passage.

### BRIEF DESCRIPTION OF THE DRAWINGS

FIG. 1 is a schematic top plan view of an exhaust gas recirculation device according to an exemplary embodiment of the present disclosure.

FIG. 2 is a cross-sectional view of one side of a cylinder head of the exhaust gas recirculation device.

FIG. 3 is a partial exploded perspective view illustrating an exhaust side of the cylinder head of the exhaust gas recirculation device.

FIG. 4 is a perspective view illustrating a swirl generator of the exhaust gas recirculation device.

### DETAILED DESCRIPTION OF THE EMBODIMENTS

Hereinafter, an exemplary embodiment of the present disclosure will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

In addition, the size and thickness of each configuration shown in the drawings are arbitrarily shown for understanding and ease of description, but the present disclosure is not limited thereto, and the thickness of layers, films, panels, regions, etc., may be exaggerated for clarity.

A part irrelevant to the description will be omitted to clearly describe the exemplary embodiment of the present disclosure, and the same elements will be designated by the same reference numerals throughout the specification.

In the following description, dividing names of components into first, second and the like is to divide the names because the names of the components are the same as each other and an order thereof is not particularly limited.

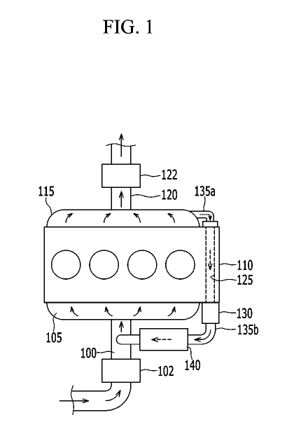

FIG. 1 is a schematic top plan view of an exhaust gas recirculation device according to an exemplary embodiment of the present disclosure.

Referring to FIG. 1, an exhaust gas recirculation device provided as part of an internal combustion engine, and includes an intake line 100, an intake control valve 102, an intake manifold 105, a cylinder head 110, an exhaust manifold 115, an exhaust line 120, a turbocharger 122, a first EGR line 135a, an EGR passage 125, an EGR valve 130, a second EGR line 135b, and an EGR cooler 140.

Intake air is supplied through the intake line 100, and the intake control valve 102 controls an intake flow rate. The intake manifold 105 distributes the intake air supplied through the intake line 100 to each combustion chamber (not illustrated) through an intake port (not illustrated).

Combusted exhaust gas in the combustion chamber is exhausted to the exhaust manifold 115 through an exhaust port (not illustrated), the exhaust manifold 115 exhausts the exhaust gas to outside through the exhaust line 120, and a turbocharger 122 operated by the exhaust gas to compress the intake air is disposed at the exhaust line 120. In particular, the turbocharger can be of any suitable structure known to one of ordinary skill in the art.

The EGR passage 125 is formed at an interior portion of one edge of the cylinder head 110, and the EGR passage 125 recirculates the exhaust gas of the exhaust manifold 115 to a side of the intake line 100.

The first EGR line 135a is diverged from the exhaust manifold 115 to be connected with an inlet side of the EGR passage 125. Here, the first EGR line 135a may be diverged from the exhaust line 120 and connected with an inlet side of the EGR passage 125.

The second EGR line 135b merges from an outlet side of the EGR passage 125 to a side of the intake line 100. Here, the second EGR line 135b may be merged from an outlet side of the EGR passage 125 to a side of the intake manifold 105.

The EGR valve 130 controlling a flow rate of the EGR gas and the EGR cooler 140 cooling the EGR gas are provided at predetermined positions at the second EGR line 135b.

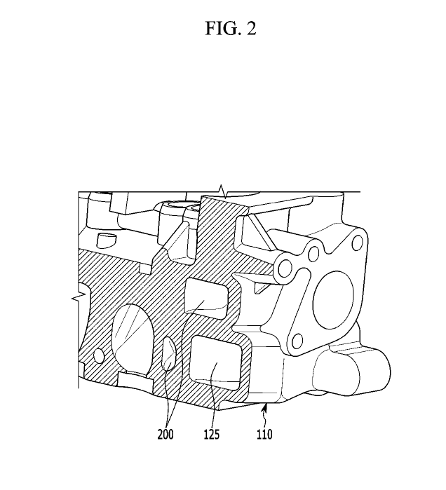

FIG. 2 is a cross-sectional view of one side of a cylinder head of the exhaust gas recirculation device.

Referring to FIG. 2, the EGR passage 125 is formed inside the cylinder head 110, and the head coolant chamber 200 is formed at an upper portion and a side of the EGR passage 125.

Coolant passing the head coolant chamber 200 cools the cylinder head 110 and the EGR gas passing through the EGR passage 125.

Accordingly, the EGR gas passing through the cylinder head 110 is first cooled by the coolant before passing through the EGR cooler 140, and thus a cooling capacity of the EGR cooler 140 may be reduced and a temperature of the EGR gas may be more stably controlled.

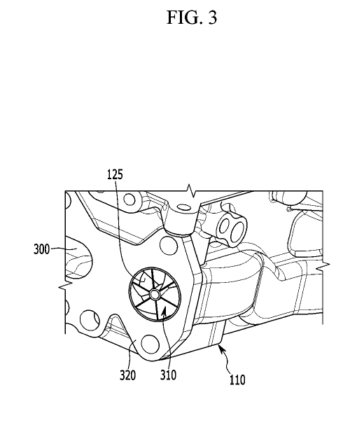

FIG. 3 is a partial exploded perspective view illustrating an exhaust side of the cylinder head of the exhaust gas recirculation device.

Referring to FIG. 3, an install surface 320 which the exhaust manifold 115 is installed is formed at the cylinder head 110, and an exhaust port 300 connected with the combustion chamber is formed at the install surface 320.

An inlet of the EGR passage 125 is formed at a side of the install surface 320, and a swirl generator 310 is inserted into and installed at the inlet of the EGR passage 125.

The swirl generator 310 generates swirl by rotating the EGR gas with reference to a center shaft of a moving direction. By this principle, cooling efficiency of the EGR gas may be improved, flow resistance of the EGR gas may be reduced, and a substantial portion of the EGR gas is configured to move rapidly.

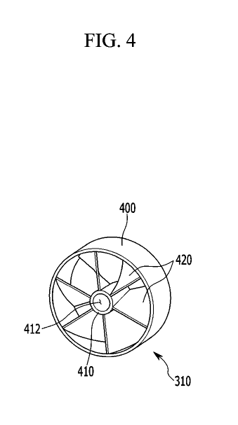

FIG. 4 is a perspective view illustrating a swirl generator of the exhaust gas recirculation device.

Referring to FIG. 4, the swirl generator 310 includes an inner pipe 410, an outer pipe 400, a swirl generating wing 420, and a center hole 412.

An exterior circumference of the outer pipe 400 closely contact an interior circumference surface, and a predetermined interval is formed between an exterior circumference surface of the inner pipe 410 and an interior circumference surface of the outer pipe 400.

The swirl generating wing 420 is formed between the inner pipe 410 and the outer pipe 400 in a predetermined interval in a circumference direction, and the swirl generating wing 420 is slantingly formed so as to form swirl at the EGR gas passing between the inner pipe 410 and the outer pipe 400.

The center hole 412 is formed at the inner pipe 410, the EGR gas passes through the center hole 412, and the EGR gas passing through the center hole 412 may have improved gas flowing stability.

While this disclosure has been described in connection with what is presently considered to be practical exemplary embodiments, it is to be understood that the disclosure is not limited to the disclosed embodiments.

1. An exhaust gas recirculation (EGR) device, comprising:
a cylinder head in which an EGR passage recirculating EGR gas from an exhaust side to an intake side is formed;
a coolant chamber formed inside the cylinder head and at a circumference of the EGR passage, through which coolant cooling the EGR gas passing through the EGR passage passes;
a swirl generator disposed at one side of the EGR passage to form swirl at the EGR gas passing through the EGR passage;
a first EGR line connecting an exhaust manifold connected to the exhaust side of the cylinder head and an inlet side of the EGR passage; and
a second EGR line connecting an outlet side of the EGR passage and an intake manifold connected to the intake side of the cylinder head,
wherein the swirl generator includes:
an outer pipe closely contacting an interior circumference of the EGR passage;
an inner pipe disposed in a predetermined interval with an interior circumference of the outer pipe; and
a swirl generating wing formed between the inner pipe and the outer pipe to form swirl at the passing EGR gas, and
wherein the exterior circumference of the outer pipe is fixed at the interior circumference of the EGR passage, and a center hole through which the EGR gas passes is formed at a center portion of the inner pipe.

2. (canceled)

3. The device of claim 1, wherein:
the swirl generator is disposed at an inlet of the EGR passage.

4. The device of claim 1, further comprising:
an EGR valve installed at one side of the second EGR line to control the recirculating exhaust gas; and
an EGR cooler installed at another side of the second EGR line to cool the recirculating exhaust gas.

5.-6. (canceled)

7. An exhaust gas recirculation (EGR) device, comprising:
a cylinder head in which an EGR passage recirculating EGR gas from an exhaust side to an intake side is formed;
a coolant chamber formed inside the cylinder head and at a circumference of the EGR passage, through which coolant cooling the EGR gas passing through the EGR passage passes; and
a swirl generator disposed at an inlet side of the EGR passage to form swirl at the EGR gas passing through the EGR passage,
wherein the swirl generator includes:
an outer pipe closely contacting and being fixed with interior circumference of the EGR passage;
an inner pipe disposed in a predetermined interval with an interior circumference of the outer pipe, and a center hole through which the EGR gas passes is formed at a center portion; and
a swirl generating wing formed between the inner pipe and the outer pipe to form swirl at the passing EGR gas.
